(19) United States
(12) Patent Application Publication
(10) Pub. No.: US 2010/0312721 A1
(43) Pub. Date: Dec. 9, 2010

(54) INFORMATION PROCESSING METHOD, INFORMATION PROCESSING APPARATUS AND COMPUTER READABLE MEDIUM

(75) Inventors: Yoshihiro TERADA, Kawasaki-shi (JP); Shinichi KOBAYASHI, Kawasaki-shi (JP); Takahiro SATO, Kawasaki-shi (JP); Takeshi OHTANI, Kawasaki-shi (JP)

Correspondence Address: SUGHRUE-265550, 2100 PENNSYLVANIA AVE. NW, WASHINGTON, DC, 20037-3213, US

(73) Assignee: FUJI XEROX CO., LTD., Tokyo (JP)

(21) Appl. No.: 12/634,051

(22) Filed: Dec. 9, 2009

(30) Foreign Application Priority Data
Jun. 4, 2009 (JP) 2009-135099

(51) Int. Cl. G06Q 50/00; G06Q 10/00; G06Q 20/00

(52) U.S. Cl. 705/400

(57) ABSTRACT

A computer readable medium storing a program causing a computer to execute a process for electronic payment, the process includes: receiving a job instruction regarding image processing; calculating a fee charged according to content of the received job instruction; execute a process for an electronic payment corresponding to the calculated fee before executing a job which is based on the job instruction; executing the job based on the job instruction after the execution of the process for the electronic payment; and outputting information of a refund when the execution of the job based on the job instruction is interrupted.

### CROSS-REFERENCE TO RELATED APPLICATIONS

This application is based on and claims priority under 35 USC 119 from Japanese Patent Application No. 2009-135099 filed on Jun. 4, 2009.

### BACKGROUND

1. Technical Field

The present invention relates to an information processing method, an information processing apparatus and a computer readable medium.

2. Related Art

A service providing apparatus has been proposed which provides a copy function, a printer function, or a facsimile function, and enables electronic payment of a fee based on the content or amount of a service provided for a user.

### SUMMARY

According to an aspect of the invention, A computer readable medium storing a program causing a computer to execute a process for electronic payment, the process includes: receiving a job instruction regarding image processing; calculating a fee charged according to content of the received job instruction; execute a process for an electronic payment corresponding to the calculated fee before executing a job which is based on the job instruction; executing the job based on the job instruction after the execution of the process for the electronic payment; and outputting information of a refund when the execution of the job based on the job instruction is interrupted.

### BRIEF DESCRIPTION OF THE DRAWINGS

Exemplary embodiment(s) of the present invention will be described in detail based on the following figures, wherein:

FIG. 1 is a schematic diagram illustrating an example of a configuration of an information processing apparatus according to a first exemplary embodiment of the invention;

FIG. 2 is a block diagram illustrating an example of a configuration of the information processing apparatus according to the first exemplary embodiment of the invention;

FIG. 3 is a flowchart illustrating an example of an operation of the information processing apparatus according to the first exemplary embodiment of the invention;

FIG. 4 is a flowchart illustrating an example of an operation of the information processing apparatus according to the first exemplary embodiment of the invention;

FIG. 5 is a flowchart illustrating an example of an operation of the information processing apparatus according to the first exemplary embodiment of the invention;

FIG. 6 is a flowchart illustrating an example of an operation of the information processing apparatus according to the first exemplary embodiment of the invention;

FIG. 7 is a flowchart illustrating an example of an operation of the information processing apparatus according to the first exemplary embodiment of the invention;

FIG. 8 is a flowchart illustrating an example of an operation of the information processing apparatus according to the first exemplary embodiment of the invention;

FIG. 9 is a diagram illustrating an example of a refund ticket according to the first exemplary embodiment of the invention;

FIG. 10 is a flowchart illustrating an example of an operation of an information processing apparatus according to a second exemplary embodiment of the invention;

FIG. 11 is a flowchart illustrating an example of an operation of the information processing apparatus according to the second exemplary embodiment of the invention; and

FIG. 12 is a flowchart illustrating an example of an operation of the information processing apparatus according to the second exemplary embodiment of the invention.

### DETAILED DESCRIPTION

### First Exemplary Embodiment

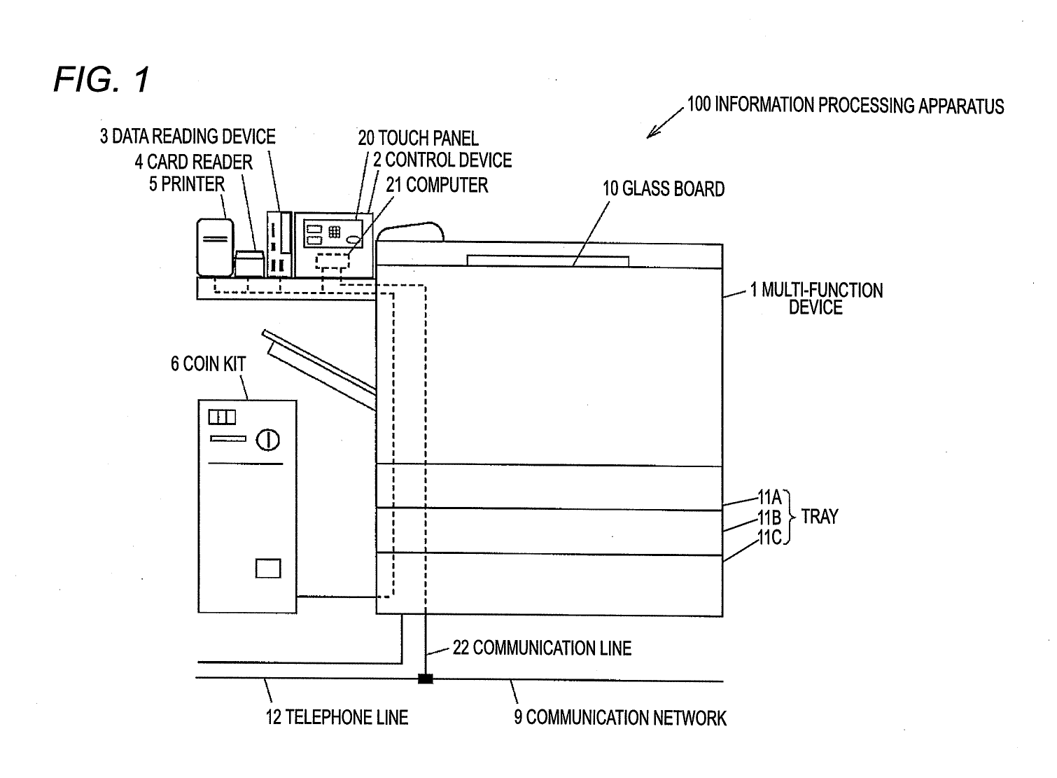

FIG. 1 is a schematic diagram illustrating an example of a configuration of an information processing apparatus according to a first exemplary embodiment of the invention. An information processing apparatus 100 is installed, for example, in stores such as convenience stores or areas such as libraries where unspecified users can use it, and is an apparatus that has a function of receiving user instructions regarding a job relating to an image process, executing the job, and executing a process for an electronic payment corresponding to fee according to the content of the job. Herein, the “image process” is to perform a process regarding an image by printing on a paper medium and the like or outputting electronic data. As a specific example, there is copying or printing of paper original documents or image data carried by a user, facsimile transmission, or the like.

(Configuration of Information Processing Apparatus 100)

The information processing apparatus 100 includes a multi-function device 1 as a first printing unit outputting an image process, a control device 2 controlling an image process job, a data reading device 3 reading electronic data stored in storage media of a user, a card reader 4 capable of reading information from the a recording medium in which electronic payment information of the user is stored, a printer 5 as an example of a second printing unit capable of printing receipts or the like, and a coin kit 6 giving and taking cash to and from the user.

(Multi-Function Device 1)

The multi-function device 1 has a copy function of reading original documents placed on the upside of a glass board 10 and copying them into sheets of printing paper stored in trays 11A, 11B, and 11C, a printer function of printing the image data read from the data reading device 3 on the sheets of printing paper, and a facsimile function of outputting original documents or electronic data to a telephone line 12, as documents to be transmitted to a destination.

(Control Device 2)

The control device 2 has a touch panel 20 on a front face thereof. The touch panel 20 is formed by overlapping a display for displaying an image with a transparent touch sensor. A user contacts the touch panel 20 while viewing the display, thereby selecting a function to use or setting printing paper size or the number of copies or prints.

The control device 2 is provided therein with a computer 21 connected to the devices constituting the information processing apparatus 100. The computer 21 is connected to a communication line 22 connected to a communication network 9 of a store in which the information processing apparatus 100 is installed.

(Data Reading Device 3)

The data reading device 3 reads image data from storage media such as CD-ROM (Compact Disk Read Only Memory) and various memory cards carried by a user. The data reading device 3 is provided with a plurality of interfaces for many kinds of storage media. Herein, the “image data” includes data about images formed of figures, photographs, text information, or tables, or data such as images in which they are mixed and images in which text information or image information is superposed on original images.

(Card Reader 4)

The card reader 4 can read information from a recording medium in which electronic payment information of a user is recorded. As such a storage medium, various things are put to practical use, such as prepaid cards, credit cards, and things built in mobile phones. In the exemplary embodiment, as an example, a case of performing electronic payment by a contactless IC card will be described. The “electronic payment” means that a fee for goods or services is paid by electronic data exchange.

The contactless IC card is a plate-shaped recording medium having a function of transmitting information about user information or information about a charged sum (money deposition) stored in a built-in memory, using electric waves of a specific frequency emitted from the card reader 4 as a driving source. The information processing apparatus 100 according to the exemplary embodiment has a function of drawing out money from the contactless IC card to performing a process for an electronic payment, but has no function of charging money to the contactless IC card.

(Printer 5)

The printer 5 is a small printer for printing and issuing a receipt or the like for a user. The printer 5 has an abnormality detecting function of detecting abnormality and outputting an abnormality signal when the printer 5 cannot print due to a shortage of printing paper or the like.

(Coin Kit 6)

The coin kit 6 has a cash receiving function of receiving cash (coins or bills, or both) inserted by a user and calculating the sum of the inserted cash, and a cash payment function of giving a user the change.

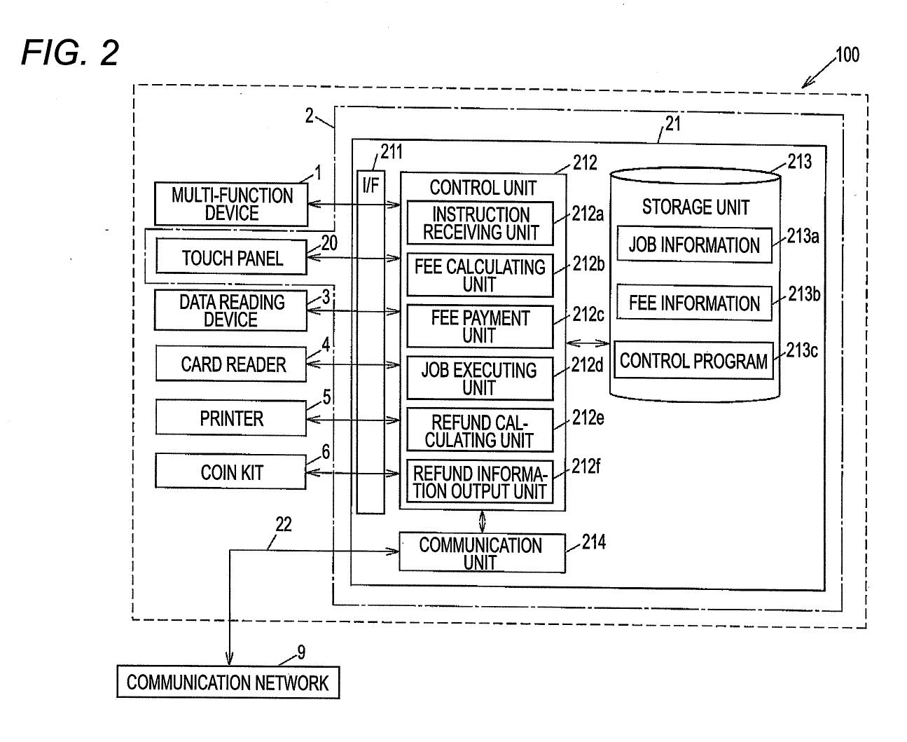

FIG. 2 is a block diagram illustrating an example of a configuration of the information processing apparatus 100 according to the first exemplary embodiment of the invention.

The control device 2 is provided with the computer 21 therein. The computer 21 is connected to the multi-function device 1, the touch panel 20 of the control device 2, the data reading device 3, the card reader 4, the printer 5, and the coin kit 6 through an interface (I/F) 211 by a communication line. The computer 21 can read information from the devices and transmit operation instructions to the devices.

A communication unit 214 of the computer 21 is connected to the communication line 22, and can transmit and receive information by access to the communication network 9 of the store or the like in which the information processing apparatus 100 is installed.

The computer 21 has a control unit 212 and a storage unit 213. A CPU (Central Processing Unit) executes a control program 213d stored in the storage unit 213, and thus the control unit 212 serves as an instruction receiving unit 212a, a fee calculating unit 212b, a fee payment unit 212c, a job executing unit 212d, a refund calculating unit 212e, a refund information output unit 212f, and the like.

The storage unit 213 is formed of memory elements such as RAM (Random Access Memory) and ROM (Read Only Memory), a hard disk, and the like. The storage unit 213 stores information of job information 213a and fee information 213b, a control program 213c, and the like, which are necessary for performing a process of the control unit 212.

### Operation of First Exemplary Embodiment

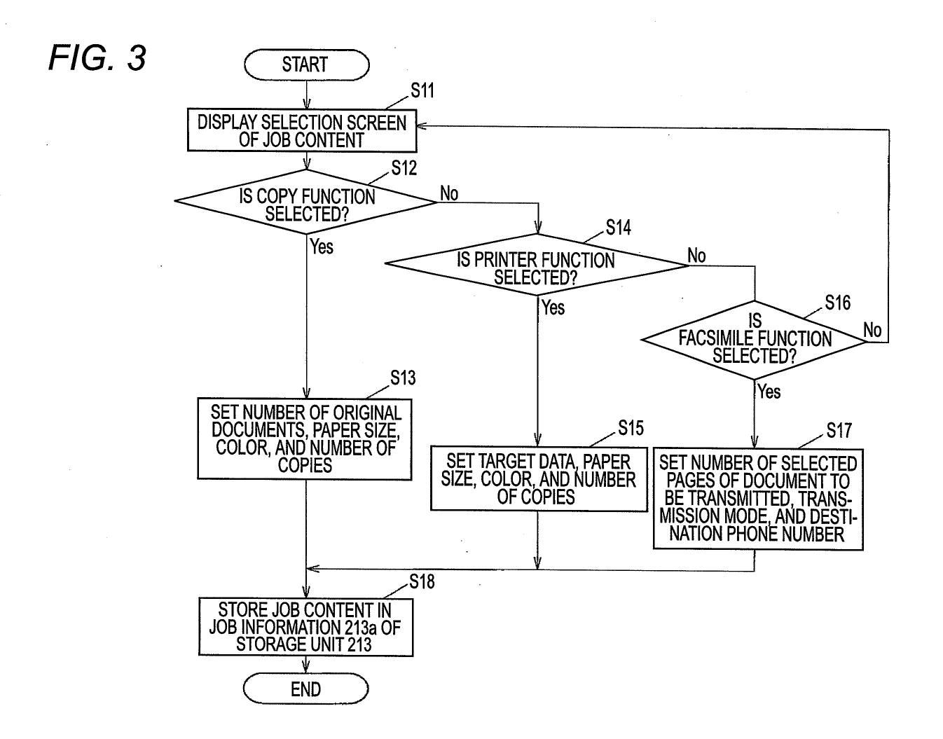

Next, an operation of the information processing apparatus 100 according to the first exemplary embodiment of the invention will be described with reference to FIG. 3 to FIG. 8. The control unit 212 executes an instruction receiving step, a fee calculating step, a fee payment step, a job executing step, a refund calculating step, and a refund information output step in order.

(Instruction Receiving Step)

FIG. 3 is a flowchart illustrating an example of a process of the instruction receiving step executed by the instruction receiving unit 212a. A user sends a job instruction to the information processing apparatus 100 according to the display of the touch panel 20 by the process of the instruction receiving step.

The instruction receiving unit 212a displays functions (copy function, printer function, and facsimile function) which can be used by the user on the touch panel (S11). When the user selects the copy function (S12: Yes), the instruction receiving unit 212a displays a screen for setting the number of original documents, the paper size, the kind of gray scale or color, or the number of copies on the touch panel 20 and sets them according to input operation of the user (S13).

When the user selects the printer function (S14: Yes), the instruction receiving unit 212a displays a screen for designating, for the performance of a printing process as target data, which interface to use of a plurality of interfaces of the data reading device 3 of which image data of storage media is connected, or for setting the paper size, the kind of gray scale or color, and the number of copies, on the touch panel 20, and sets them according to input operation of the user (S15).

When the user selects the printer function (S16: Yes), the instruction receiving unit 212a displays a screen for setting which of an original document placed on the glass board 10 of the multi-function device 1 or image data of the storage medium connected to the data reading device 3 is designated as a transmission destination original document, and for setting the number of pages, transmission modes (designation of resolution or the like), or a destination phone number, on the touch panel 20, and sets them according to input operation of the user (S17).

Next, the instruction receiving unit 212a receives the information set in Steps S13, S15, or S16 as a job instruction, and stores the content thereof as the job information 213a in the storage unit 213 (S18).

(Fee Calculating Step)

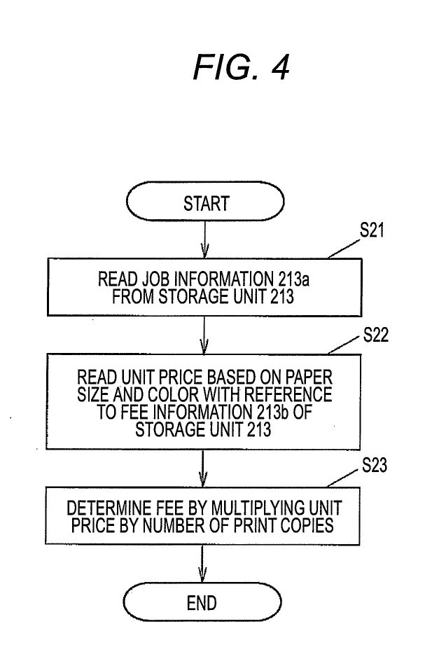

FIG. 4 is a flowchart illustrating an example of a process of the fee calculating step executed by the fee calculating unit 212b.

Hereinafter, a case of selecting the printer function will be described by way of example.

First, the fee calculating unit 212b reads the job information 213a (S21), and calculates a unit price per print with reference to the fee information 213b on the basis of the set information of the paper size and color stored in the instruction receiving step (S22). Then, the fee calculating unit 212b multiplies the calculated unit price by the number of prints, thereby calculating a fee charged for the user (S23).

(Fee Payment Step)

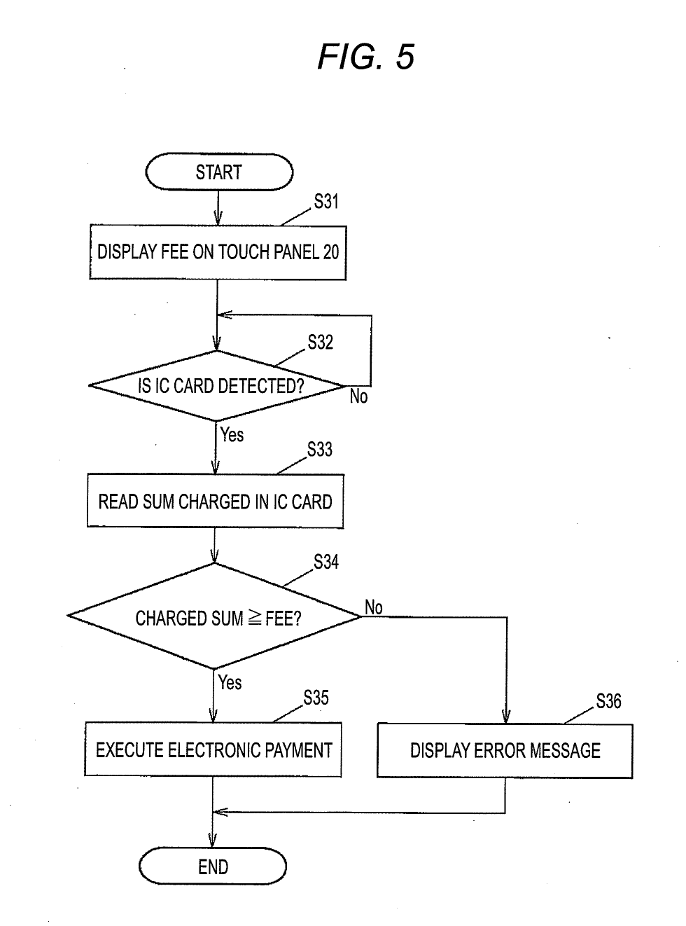

FIG. 5 is a flowchart illustrating an example of a process of the fee payment step executed by the fee payment unit 212c.

The fee payment unit 212c displays the fee calculated by the fee calculating unit 212b on the touch panel 20 (S31), and waits until the card reader 4 detects the contactless IC card of the user. When the user inserts the contactless IC card into the card reader 4 and the card reader 4 detects the contactless IC card, the fee payment unit 212c reads the sum charged in the contactless IC card (S33). Then, the fee payment unit 212c compares the charged sum with the fee calculated by the fee calculating unit 212b. When the charged sum is equal to or greater than the fee (S34: Yes), the fee payment unit 212c performs the electronic payment (S35). When the charged sum is less then the fee (S34: No), an error message representing that the charged sum is insufficient is displayed on the touch panel 20 (S36) and the process is ended.

(Job Executing Step)

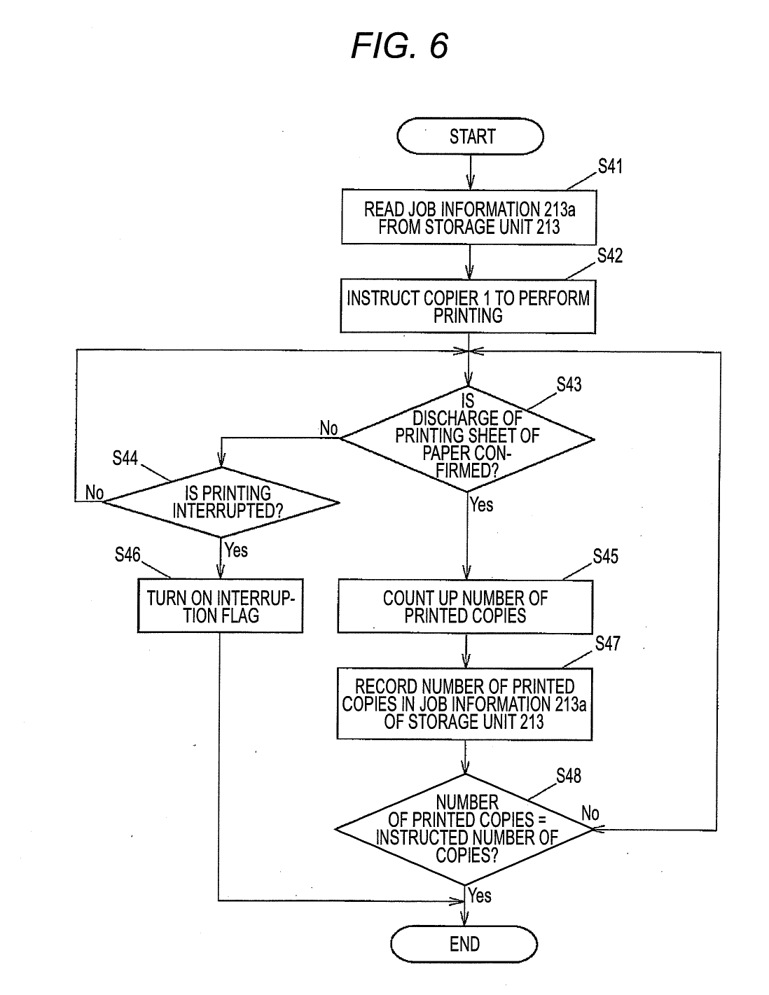

FIG. 6 is a flowchart illustrating an example of a process of the job executing step executed by the job executing unit 212d.

First, the job executing unit 212d reads the job information 213a from the storage unit 213 (S41), designates the set paper size and color on the basis of the content thereof, and instructs the multi-function device 1 to perform a printing process (S42).

Next, the job executing unit 212d confirms whether or not a confirmation signal representing that one printed sheet of paper is discharged from the multi-function device 1 is turned on. When the confirmation signal is turned on (S43: Yes), the number of prints is counted up (S45). When the confirmation signal is not turned on (S43: No), the job executing unit 212d confirms whether or not there is an interruption of the printing job (S44). When there is an interruption of the printing job (S44: Yes), an interruption flag is turned on (S46) and the process of the job executing step is ended. When there is no interruption of the printing job (S44: No), the job executing unit 212d confirms whether or not the sheet of printing paper is discharged in Step S43 again.

The interruption of the printing job may occur, for example, when the user recognizes that the selection of image data as a printing target is wrong from the already output print result, or when the user wants to change the setting of the paper size or color. In this case, the user instructs the interruption of the printing by operating the touch panel 20. In addition, there is a case where a signal of printing interruption is transmitted from the multi-function device 1 since the job cannot be executed due to a problem of the multi-function device 1 such as a shortage of printing paper or a paper jam.

The information of the number of prints after the count-up in Step S45 is recorded in the job information 213a as a progress of the job (S47). The number of prints is cleared to zero at the time of starting the job executing step.

Next, the job executing unit 212d determines whether or not the number of prints has reached the number instructed by the user (S48). When the number of prints reaches the number instructed by the user, the process is ended (S48: Yes). When the number of prints does not reach the number instructed by the user (S48: No), the process returns to Step S43 and the job executing unit 212d confirms whether or not the next sheet of printing paper is discharged.

(Refund Calculating Step)

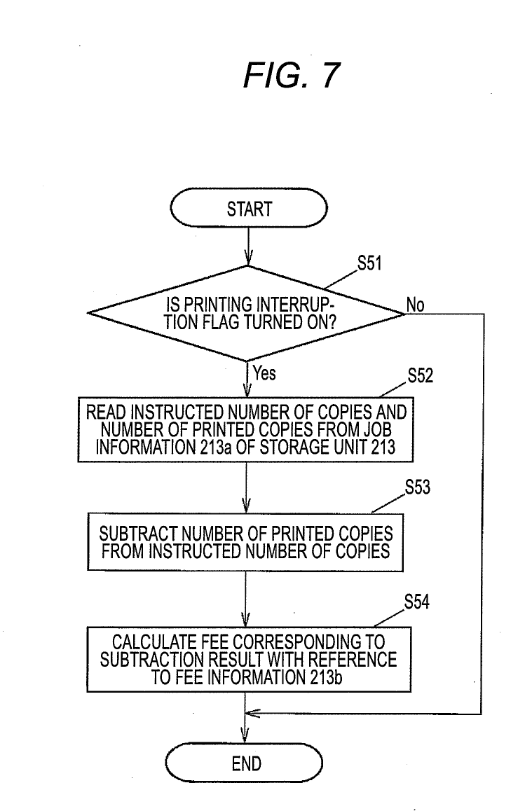

FIG. 7 is a flowchart illustrating an example of a process of the refund calculating step executed by the refund calculating unit 212e.

First, the refund calculating unit 212e determines whether or not the printing job was interrupted by the state of the interruption flag turned on in Step S46 when the printing job was interrupted (S51). When the printing job was not interrupted (S51: No), the refund calculating unit 212e ends the process of the refund calculating step. When the printing job was interrupted (S51: Yes), the refund calculating unit 212e reads the print number (instructed number) instructed to the user and the number of prints recorded as the progress with reference to the job information 213a of the storage unit 213 (S52).

Next, the refund calculating unit 212e subtracts the number of prints from the instructed number (S53). Then, the refund calculating unit 212e calculates a fee corresponding to the difference in the number of sheets calculated in Step S53 with reference to the fee information 213b and considers the fee as a refund to the user (S54).

(Refund Information Output Step)

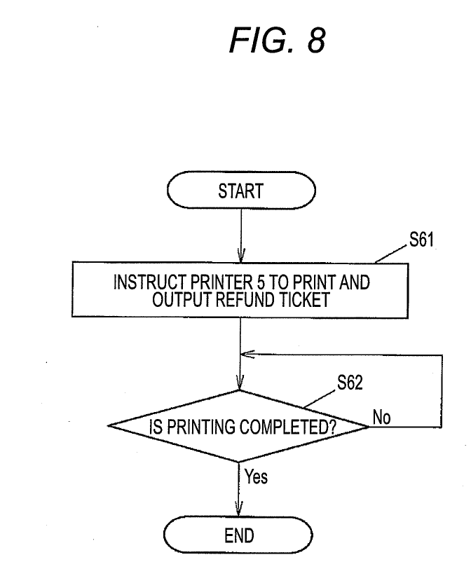

FIG. 8 is a flowchart illustrating an example of a process of the refund information output step executed by the refund information output unit 212f.

The refund information output unit 212f instructs the printer 5 to print a refund ticket including text information of the refund calculated in Step S54 (S61).

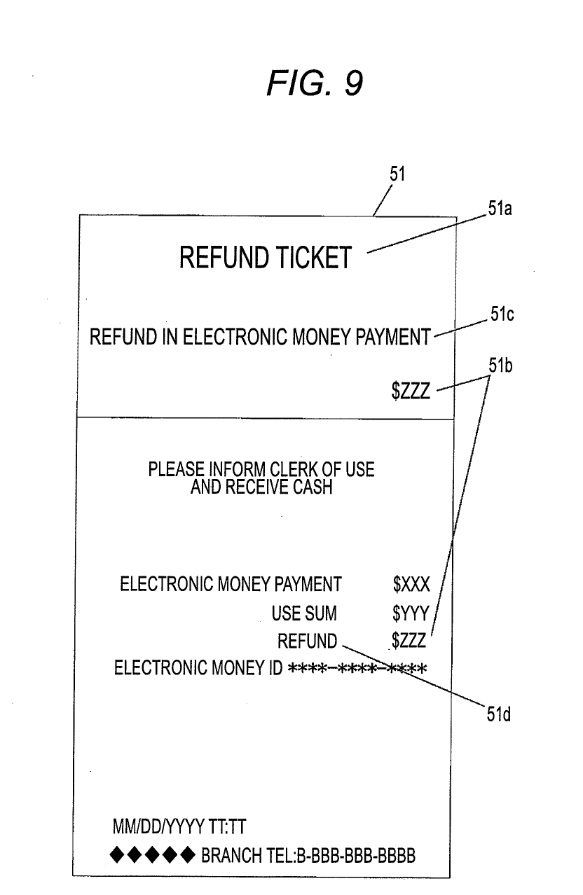

FIG. 9 shows an example of the refund ticket. As shown in FIG. 9, a mark representing the print is a refund ticket (“Refund Ticket”: 51a), text information of the refund (“$ZZ,ZZZ”: 51b), and text information representing that the text information is the refund (“Electronic Money Payment Refund”: 51c, “Refund”: 51d) are printed on the refund ticket 51.

The refund information output unit 212f waits until the printout of the refund ticket 51 by the printer 5 is completed, and when the refund information output unit 212f receives the completion notification from the printer 5 (S62: Yes), the process is ended.

When the instructed job is interrupted or the job is interrupted by a problem of the multi-function device 1, the user cuts the refund ticket 51 from a paper discharge unit of the printer 5 and shows it to a clerk or the like. Then, the user receives the refund in cash or by a deposit process to the contactless IC card.

In the exemplary embodiment, the case of selecting the printer function has been described by way of example. However, in addition, when the copy function is selected, the number of sheets of copied and discharged printing paper is counted up and the number is recorded as the progress in the job information 213a, in the same manner. When the copy job is interrupted, the refund can be calculated on the basis of the information of the number of copies recorded in the job information 213a. In addition, when the facsimile function is selected, the number of copies transmitted to the destination is recorded as the progress in the job information 213a. When the transmission process is interrupted, the refund can be calculated on the basis of the number of transmitted copies recorded in the job information 213a. As described above, the progress for each minimum unit of the output regarding the content of the job instruction is recorded in the job information 213a as needed.

### Second Exemplary Embodiment

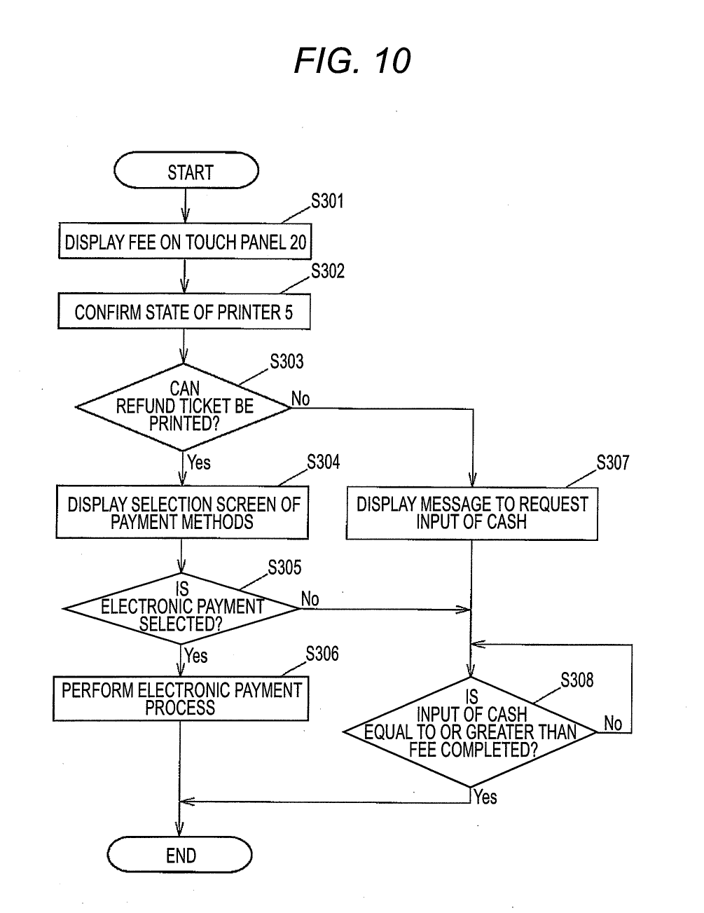

Next, an operation of a second exemplary embodiment of the invention will be described with reference to FIG. 10 to FIG. 12. The information processing apparatus 100 according to the second exemplary embodiment of the invention is different from the first exemplary embodiment in that the fee payment unit 212c is provided with a unit for performing a process for electronically paying a fee and a unit for performing a process for paying a fee in cash, and the payment method that can be selected by a user is restricted according to circumstances.

A diagram illustrating an example of a configuration of the second exemplary embodiment is the same as FIG. 1 and FIG. 2, and thus is not shown. The control unit 212 in the second exemplary embodiment executes an instruction receiving step, a fee calculating step, a fee payment step, a job executing step, a refund calculating step, and a refund information output step in order in the same manner as the first exemplary embodiment. The instruction receiving step, the fee calculating step, and the job executing step are the same as those of the first exemplary embodiment, and thus detailed description thereof is not repeated.

(Fee Payment Step)

FIG. 10 is a flowchart illustrating an example of a process of the fee payment step executed by the fee payment unit 212c according to the exemplary embodiment.

First, the fee payment unit 212c displays a fee calculated by the fee calculating unit 212b on the touch panel 20 (S301). Then, the fee payment unit 212c confirms the state of the printer 5 according to whether or not there is an abnormality signal (S302), and determines whether or not a refund ticket can be printed (S303).

When the refund ticket can be printed (S303: Yes), a screen allowing the user to select any one of electronic payment or cash payment is displayed on the touch panel 20 (S304). When the user selects the electronic payment (S305: Yes), an electronic payment process (S306) is performed. The electronic payment process (S306) is the same process as Step S31 to Step S36 described regarding the fee payment step of the first exemplary embodiment, and thus detailed description thereof is not repeated herein. When the user selects the cash payment (S305: No), the fee payment unit 212c waits until cash equal to or greater than the fee is inserted to the coin kit 6 (S308: No). When the cash equal to or greater than the fee is inserted (S308: Yes), the process is ended and the fee is collected.

Meanwhile, when the refund ticket cannot be printed in Step S303 (S303: No), the fee payment unit 212c displays a message urging the user to insert cash into the coin kit 6 on the touch panel 20. Then, the fee payment unit 212c waits until cash equal to or greater than the fee is inserted into the coin kit 6 (S308: No). When the case equal to or greater than the fee is inserted (S308: Yes), the process is ended.

(Refund Calculating Step)

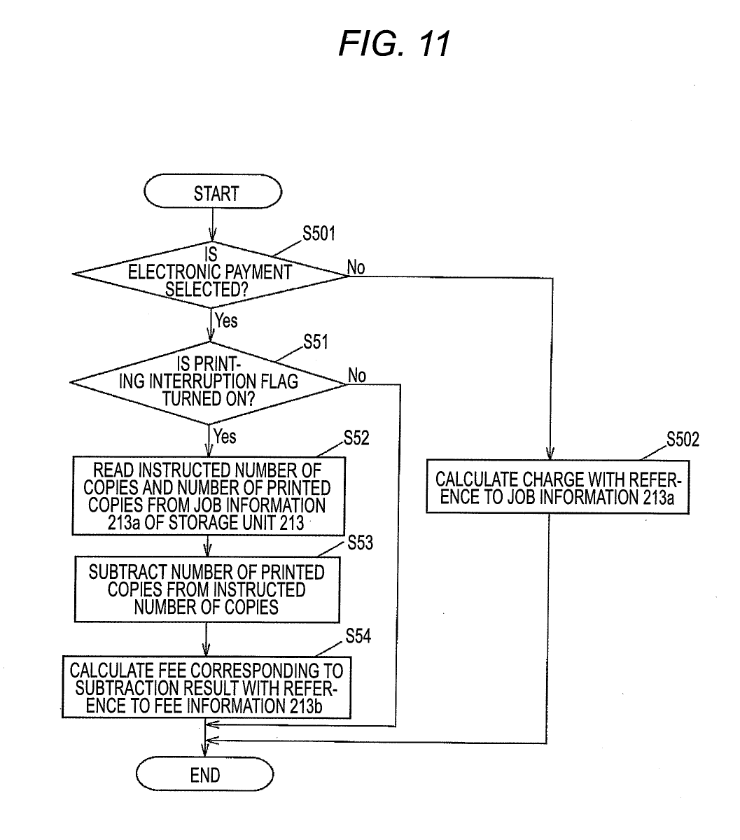

FIG. 11 is a flowchart illustrating an example of a process of the refund calculating step executed by the refund calculating unit 212e according to the exemplary embodiment. First, the refund calculating unit 212e determines whether the payment method is the electronic payment or the cash payment. When the payment method is the electronic payment (S501: Yes), the refund calculating unit 212e performs the processes from Step S51 to Step S55. The processes of the steps are the same as the description regarding the refund calculating step in the first exemplary embodiment, and thus detailed description thereof is not repeated.

When the payment method is the cash payment (S501: No), the refund calculating unit 212e calculates a refund (sum of change) to the user by subtracting the fee of the number of actually printed copies from the sum inserted into the coin kit 6 with reference to job information 213a (S502).

(Refund Information Output Step)

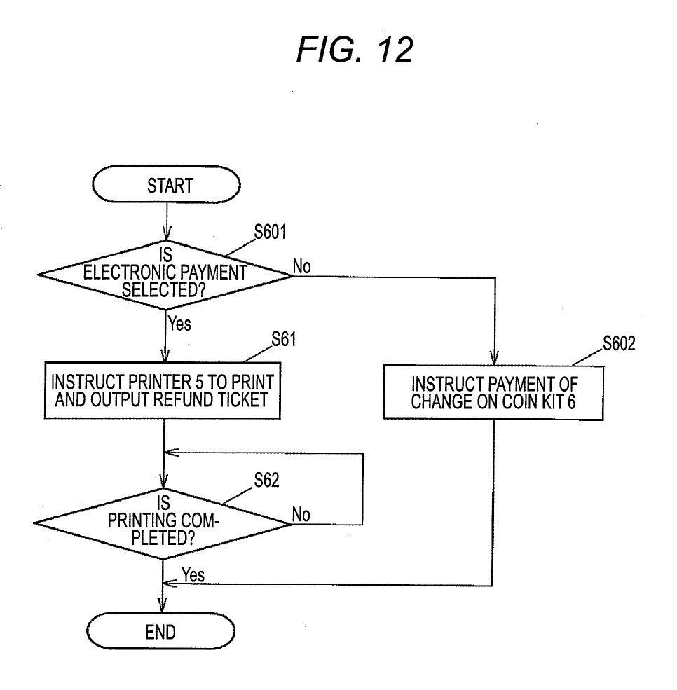

FIG. 12 is a flowchart illustrating an example of a process of the refund information output step executed by the refund information output unit 212f according to the exemplary embodiment. First, the refund information output unit 212f determines whether the payment method is the electronic payment or the cash payment. When the payment method is the electronic payment (S601: Yes), the processes of Step S61 and Step S62 are performed. The processes of the steps are the same as the description regarding the refund information output step in the first exemplary embodiment, and thus detailed description thereof is not repeated.

When the payment method is the cash payment (S601: No), the refund information output unit 212f instructs the coin kit 6 to pay cash corresponding to the refund (sum of change) calculated in the refund calculating step (S602).

As described above, the information processing apparatus 100 according to the second exemplary embodiment performs the payment by one payment method selected by the user from the first payment method of the electronic payment of the fee and the second payment method of the cash payment of the fee when the information of the refund can be output in the refund information output step, and performs the payment by the cash payment method when the information of the refund cannot be output. The electronic payment is impossible in the state where the refund ticket cannot output when the job is interrupted.

### Another Exemplary Embodiment

The invention is not limited to the above-described exemplary embodiments, and may be variously modified within the scope of the invention. The constituent elements of the exemplary embodiments may be arbitrarily combined or a part of the constituent elements may be omitted for simplification within the scope of the invention.

In the exemplary embodiment, the information of the refund is output by the printing of the refund ticket performed by the printer 5, but the invention is not limited thereto. The information of the refund may be output as an electrical signal to the communication network 9 (e.g., a POS (Point Of Sale) system) of a facility (e.g., a convenience store) where the information processing apparatus 100 is installed. In this case, a person in charge (e.g., clerk) of the facility confirms the information of the refund using a terminal device and refunds the user.

When the information of the refund cannot be output as an electrical signal due to a malfunction of the communication unit 214 or the communication network 9, the electronic payment is set to be impossible and the cash payment may be performed.

Even though neither the communication unit 214 nor the communication network 9 are faulty, for example, when the information of the refund cannot be used as the person in charge of the facility cannot confirm the information of the refund since the terminal device is faulty, the electronic payment is set to be impossible and the cash payment may be performed. It can be determined whether or not the information of the refund can used, for example, by the content of a response to transmission of information requiring notification of the reception side situation regarding the use (e.g., when the response does not return, it is determined that the information of the refund cannot be used).

The computer 21 is not limited to being built in the control device provided with the touch panel 20, and may be built in the multi-function device 1. The target of the control is not limited to the multi-function device having the copy function, the printer function, and the facsimile function, and may have one or two of these functions or may have other functions.

In the exemplary embodiments, the case where the information processing apparatus 100 does not have the function of charging to the contactless IC card has been described, but the invention may be applied to an information processing apparatus having the charging function.

When the sum of receipt is equal to or more than 30,000 yen requiring the attachment of a revenue stamp at the time the receipt is issued by the printer 5, a message urging the user to collect a receipt issued in a register or the like of a store may be displayed on the touch panel 20 without printing the receipt.

A part or the entirety of the program used according to the exemplary embodiments may be configured by hardware. The program used according to the exemplary embodiments may be downloaded from the network to the storage unit of the information processing apparatus, and may be taken from the storage medium such as CD-ROM to the storage unit of the information processing apparatus.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A computer readable medium storing a program causing a computer to execute a process for electronic payment, the process comprising:
receiving a job instruction regarding image processing;
calculating a fee charged according to content of the received job instruction;
execute a process for an electronic payment corresponding to the calculated fee before executing a job which is based on the job instruction;
executing the job based on the job instruction after the execution of the process for the electronic payment; and
outputting information of a refund when the execution of the job based on the job instruction is interrupted.

2. The computer readable medium according to claim 1, the process further comprising:
prohibiting the execution of the process for the electronic payment when the output of the information of the refund is unavailable.

3. The computer readable medium according to claim 1, the process further comprising:
prohibiting the execution of the process for the electronic payment when the information of the refund is unavailable from a terminal device configured to receive the information through a communication network.

4. The computer readable medium according to claim 1, wherein
the job relates to a printing job;
the executing the job includes executing the printing job by a first printing unit; and
the outputting the information of the refund includes printing the information of the refund by a second printing unit different from a first printing unit.

5. An information processing method comprising:
receiving a job instruction regarding image processing;
calculating a fee charged according to content of the received job instruction;
execute a process for an electronic payment corresponding to the calculated fee before executing a job which is based on the job instruction;
executing the job based on the job instruction after the execution of the process for the electronic payment; and
outputting information of a refund when the execution of the job based on the job instruction is interrupted.

6. An information processing apparatus comprising:
an instruction receiving unit that receives a job instruction regarding image processing;
a fee calculating unit that calculates a fee charged according to content of the received job instruction;
en electronic payment unit that execute a process for an electronic payment corresponding to the calculated fee before executing a job which is based on the job instruction;
a job executing unit that executes the job based on the job instruction after the execution of the process for the electronic payment; and
a refund information output unit that outputs information of a refund when the execution of the job based on the job instruction is interrupted.
